(19) United States
(12) Patent Application Publication
(10) Pub. No.: US 2004/0061889 A1
(43) Pub. Date: Apr. 1, 2004

(54) System and method for distributing centrally located pre-processed medical image data to remote terminals

(75) Inventors: Chris H. Wood, North Bend, WA (US); Justin P. Smith, Hunts Point, WA (US); Tanya L. Lancaster, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Confirma, Inc., Kirkland, WA (US)

(21) Appl. No.: 10/260,734

(22) Filed: Sep. 27, 2002

(51) Int. Cl. G06K 1/00; B41J 1/00

(52) U.S. Cl. 358/1.15

(57) ABSTRACT

An apparatus distributes processed image data from a central location to remote terminals, for viewing by medical personnel for the purposes of diagnosis and determining a treatment regimen for a patient. The apparatus receives image data from imaging devices, and is programmed with rules or other parameters with respect to the manner in which that image data is to be processed and sorted. The apparatus applies the parameters to the appropriate received image data, and distributes the processed image data to one or more remotely coupled terminals. Because the image data is automatically pre-processed by the apparatus according to various parameters that are specific to certain medical personnel's preferences (or specific to other factors), the amount of repetitive user-required configuration and repetitive workstation processing is reduced—simple remote terminals with limited processing capability can receive highly customized image data.

### TECHNICAL FIELD

This disclosure generally relates to distribution of image data, and in particular but not exclusively, relates to a system and method for distributing medical image data from a centralized processing location to remote terminals.

### BACKGROUND INFORMATION

The collection and storage of a large number of medical images is currently carried out by a number of systems. The medical images can be collected by a variety of techniques, such as magnetic resonance imaging (MRI), computed tomography (CT), ultrasound, and x-rays. One system for collecting a large number of medical images of a human body is disclosed U.S. Pat. Nos. 5,311,131 and 5,818,231 to Smith. These patents describe an MRI apparatus and method for collecting a large number of medical images in various data sets. The data are organized and manipulated in order to provide visual images to be read by medical personnel to perform a diagnosis.

One of the problems in reading a large number of images is for the medical personnel to understand the relationship of the images to each other while performing the reading. Another difficult task is interpreting the medical significance of various features that are shown in the individual images. Being able to correlate the images with respect to each other is extremely important in deriving the most accurate medical diagnosis from the images and in setting forth a standard of treatment for the respective patient. The images can be from the same anatomic location and vary with respect to contrast, or from different anatomic locations, or both. Registration is a processing step that can align images from different modalities or correct for patient motion within a modality. Unfortunately, such a coordination of multiple images with respect to each other is extremely difficult and even highly trained medical personnel, such as experienced radiologists, have extreme difficulty in consistently and properly interpreting a series of medical images so that a treatment regime can be instituted that best fits the patient's current medical condition.

Another problem encountered by medical personnel today is the large amount of data and numerous images that are obtained from current medical imaging devices. The number of images collected in a standard scan is usually in excess of 100 and very frequently numbers in the many hundreds. In order for medical personnel to properly review each image takes a great deal of time, and with the many images that current medical technology provides, a great amount of time is required to thoroughly examine all the data.

To assist medical personnel in their analysis and interpretation of the large volume of medical images, specialized workstations are typically provided at hospitals (or other institutions). The image data acquired by the imaging devices are sent to these workstations, and the workstations have image processing hardware and software that can manipulate the acquired image data into image formats that medical personnel can more readily review in order to identify tissues of interest. For example, contrast agents are types of drugs that may be administered to a patient. If given, contrast agents typically distribute in various compartments of the body over time and provide some degree of enhanced image for interpretation by the medical personnel at the workstation. In addition to the above, pre- and post-contrast sequence data series can be acquired for use in comparison at the workstation.

When displayed as an image by the workstation, the collected data can be represented as pixels, voxels, or any other suitable representation generated by the image processing capabilities of the workstation. Within the visual display of the workstation, the intensity, color, and other features of the respective data point (whether termed a pixel, voxel, or other representation) provides an indication of the medical parameter of interest. The medical image thus contains a large number of pixels, each of which contain data corresponding to one or more medical parameters within a patient.

Workstations typically receive their image data with minimal or no pre-processing or registration of that image data. As a result, most (if not all) of the image processing occurs at and is performed by the workstation for each and every image. This creates substantial processing overhead and latency issues, particularly in situations where a radiologist has requested a large number of complex images for processing and viewing—each and every image requested by the radiologist has to be processed and sorted by the workstation according to the parameters provided by the radiologist. Moreover, workstations often require the medical personnel themselves to provide the configuration information and other parameters by which the images are to be processed, sorted, and displayed. This requirement is cumbersome for medical personnel that are not computer savvy, and is extremely inconvenient in situations where the workstation requires the same repetitive information to be provided by a radiologist each time images from a new patient are requested, each time images from different studies for the same patient are requested, each time a different radiologist uses the workstation, and so forth.

For some workstations, the various parameters used for processing, sorting, and displaying the medical images are preset and applied universally to all images. While this preset information does reduce the need for the medical personnel to explicitly provide the information, it is an undesirably inflexible solution. For instance, different patients have variances in tissues and images acquired therefrom—if the same image processing and sorting parameters are universally applied to images of all patients by the workstation, less-than-accurate results are provided. Furthermore, different medical personnel have different preferences as to the image data that they wish to analyze—what may be viewed as significant tissues of interest by one radiologist may be viewed as less significant by another radiologist, because the pixel intensity does or does not fall within a certain range, for instance. The preset parameters force all of the medical personnel to undesirably adopt “the same standard,” or to adjust their individual independent analysis to account for the standardization of the images.

Generally, most institutions have only one or two workstations because they are extremely expensive (e.g., costing hundreds of thousands of dollars). To help alleviate the costs involved with obtaining multiple workstations and to reduce the demand at any single workstation, institutions typically implement Picture Archive and Communication System (PACS) terminals. A PACS terminal is generally an inexpensive reading station with minimal image processing capabilities (such as magnification or other simple/basic viewing capability)—they are “dumb terminals” that merely display remotely stored, static (e.g., “archived”) image data. If the medical personnel using a PACS terminal wishes to perform more complex image processing and sorting in a particular manner (different than what has already been preset for the PACS terminals and/or for a main workstation or to generate images different than what has been archived), then the medical personnel would have to go to the main workstation to perform the cumbersome configuration and information entry (if it is even possible to change the preset information or archived images), and then output the newly processed images to the PACS terminal(s) or view the new images from the main workstation. This is an impractical solution for situations where medical personnel analyze images based on different parameters and for situations where there are significant physical distances (or other logistical difficulties) between PACS terminals and the main workstation where the configuration needs to be performed.

### BRIEF SUMMARY OF THE INVENTION

According to one aspect of the present invention, a central location is configured to centrally process image data and to distribute the processed image data to at least some remote recipients having minimal image data processing capabilities. The image data is received at the central location. The received image data is then centrally processed at the central location according to at least one image processing parameter, from among a plurality of available image processing parameters, associated with at least one of the remote recipients. The processed image data is sent to the remote recipient associated with the image processing parameter used during the central processing.

### BRIEF DESCRIPTION OF THE SEVERAL VIEWS OF THE DRAWINGS

FIG. 1 is a schematic view of a data collection system according to the prior art.

FIG. 2 is a schematic representation of the various images that may be obtained from a data collection system.

FIG. 3 is a block diagram of a network having an apparatus that can provide centrally located pre-processed image data to remote terminals in accordance with an embodiment of the invention.

FIG. 4 is a block diagram showing one embodiment of the apparatus of FIG. 3 in more detail.

FIGS. 5-9 show different example screen shots of administrative interfaces that may be used to configure the apparatus of FIGS. 3-4 according to various embodiments of the present invention.

FIG. 10 shows a screen shot of a user interface that can be used by a remote terminal to present image data that has been pre-processed by the apparatus of FIGS. 3-4 in accordance with an embodiment of the invention.

### DETAILED DESCRIPTION

Embodiments of techniques to distribute centrally located image data to remote terminals are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention provides an apparatus that can distribute processed image data from a central location to remote terminals, for viewing by medical personnel (such as radiologists) for the purposes of diagnosis and determining a treatment regimen for a patient. The apparatus receives image data from imaging devices, and according to one embodiment, can be programmed with various rules or other parameters with respect to the manner in which that image data is to be processed and sorted. For example, the apparatus may be programmed to use (different) parameters specifically preferred by certain doctors for certain types of studies. Once programmed with these parameters, the apparatus applies the parameters to the appropriate received image data, and need not be repetitively re-programmed with the same parameters each time new image data (for which the existing parameters are applicable) is received from the imaging devices.

The image data processed and sorted by the apparatus is then distributed by the apparatus to one or more remotely coupled terminals, such as PACS terminals. In one embodiment, the image data (embodied as medical images, for instance) are distributed to the correct PACS terminal(s) based on a determination of which recipient is to receive the processed image data, such as particular medical personnel that may use that PACS terminal or based on the types of images that the PACS terminal is designated to display. Alternatively or in addition, medical personnel may use any PACS terminal and request the desired images via a menu or other selection tool available through the PACS terminal. Because the image data is automatically pre-processed by the apparatus according to various parameters that are specific to certain medical personnel's preferences (or specific to other factors), the amount of repetitive user-required configuration and repetitive workstation processing is reduced—the radiologist can be very easily and very efficiently presented with the appropriate images at the PACS terminal with minimal effort required on his/her part. Institutions, therefore, need not make large financial investments in multiple workstations, and instead less-expensive PACS terminals or other simple inexpensive display terminals may be used to access centrally processed (and customized) image data.

For purposes of explanation and illustration, embodiments of the invention will be described herein in the context of magnetic resonance imaging (MRI) and related analysis. It is appreciated that other embodiments of the invention may be applied to other medical imaging technologies, including but not limited to, nuclear magnetic resonance (NMR), computed tomography (CT), positron emission tomography (PET), ultrasound, x-rays, and other imaging technique. Some embodiments of the invention may also be used in connection with imaging technologies that are not necessarily medical in nature.

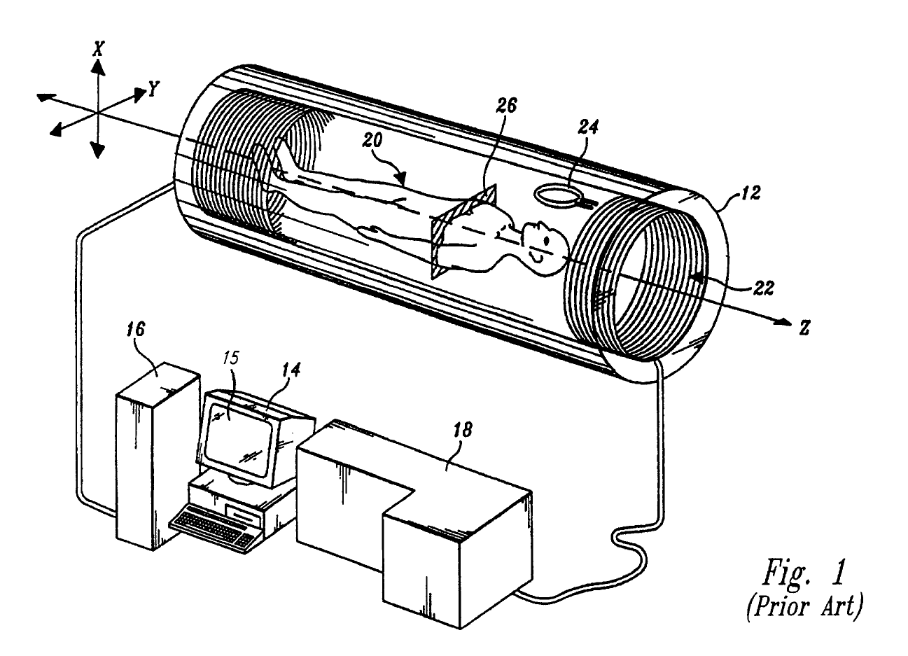

Beginning initially with FIG. 1, shown therein is a known sensor and data collection device as described in U.S. Pat. No. 5,644,232. It illustrates one technique by which data can be collected for analysis for use by one embodiment of the present invention. It is appreciated that other types of imaging devices may be used to acquire images.

Details of magnetic resonance imaging methods are disclosed in U.S. Pat. No. 5,311,131, entitled, “MAGNETIC RESONANCE IMAGING USING PATTERN RECOGNITION;” U.S. Pat. No. 5,644,232, entitled, “QUANTITATION AND STANDARDIZATION OF MAGNETIC RESONANCE MEASUREMENTS;” and U.S. Pat. No. 5,818,231, entitled, “QUANTITATION AND STANDARDIZATION OF MAGNETIC RESONANCE MEASUREMENTS.” The above-referenced three patents are incorporated in their entirety herein by reference. The technical descriptions in these three patents provide a background explanation of one environment for the invention and are beneficial to understand the present invention.

Pattern recognition is utilized in several disciplines and the application of thresholding as described with respect to this invention is pertinent to all of these fields. Without the loss of generality, the examples and descriptions will all be limited to the field of MRI for simplicity. Of particular interest is the application of pattern recognition technology in the detection of similar lesions such as tumors within magnetic resonance images. Therefore, additional background on the process of MRI and the detection of tumor using MRI is beneficial to understanding embodiments of the invention.

Magnetic resonance (MR) is a widespread analytical method used routinely in chemistry, physics, biology, and medicine. Nuclear magnetic resonance (NMR) is a chemical analytical technique that is routinely used to determine chemical structure and purity. In NMR, a single sample is loaded into the instrument and a representative, multivariate, chemical spectrum is obtained. The magnetic resonance method has evolved from being only a chemical/physical spectral investigational tool to an imaging technique, MRI, that can be used to evaluate complex biological processes in cells, isolated organs, and living systems in a non-invasive way. In MRI, sample data are represented by an individual picture element, called a pixel, and there are multiple samples within a given image.

Magnetic resonance imaging utilizes a strong magnetic field for the imaging of matter in a specimen. MRI is used extensively in the medical field for the noninvasive evaluation of internal organs and tissues, including locating and identifying benign or malignant tumors.

As shown in FIG. 1, a patient 20 is typically placed within a housing 12 having an MR scanner, which is a large, circular magnet 22 with an internal bore large enough to receive the patient. The magnet 22 creates a static magnetic field along the longitudinal axis of the patient's body 20. The magnetic field results in the precession or spinning of charged elements such as the protons. The spinning protons in the patient's tissues preferentially align themselves along the direction of the static magnetic field. A radio frequency electromagnetic pulse is applied, creating a new temporary magnetic field. The proton spins now preferentially align in the direction of the new temporary magnetic field. When the temporary magnetic field is removed, the proton spin returns to align with the static magnetic field. Movement of the protons produces a signal that is detected by an antenna 24 associated with the scanner. Using additional magnetic gradients, the positional information can be retrieved and the intensity of the signals produced by the protons can be reconstructed into a two- or three-dimensional image.

The realignment of the protons' spin with the original static magnetic field (referred to as “relaxation”) is measured along two axes. More particularly, the protons undergo a longitudinal relaxation (T₁) and transverse relaxation (T₂). Because different tissues undergo different rates of relaxation, the differences create the contrast between different internal structures as well as a contrast between normal and abnormal tissue. In addition to series of images composed of T₁, T₂, and proton density, variations in the sequence selection permit the measurement of chemical shift, proton bulk motion, diffusion coefficients, and magnetic susceptibility using MR. The information obtained for the computer guided tissue segmentation may also include respective series that measure such features as: a spin-echo (SE) sequence; two fast spin-echo (FSE) double echo sequences; and fast short inversion time inversion recovery (FSTIR), or any of a variety of sequences approved for safe use on the imager. Further discussion of T₁-weighted and T₁-weighted images and the other types of images identified above (and various techniques to process and interpret these images) are provided in the co-pending application(s) referenced herein and in the available literature, and are not repeated herein for purposes of brevity.

As previously described above, contrast agents are types of drugs that may be administered to the subject in order to provide enhanced images. When the contrast agents distribute in various compartments of the body over time, the images generated from tissues that have absorbed the contrast agents will have different pixel intensities. The pixel intensities, the rates at which the contrast agents are absorbed by tissue (often referred to as “uptake”), the rates at which the pixel intensities decrease (often referred to as “washout”), and other characteristics vary from one patient to another and from one type of tissue to another. As an example, fatty tissue has different uptake and washout rates than malignant tissue. Healthy tissue has different uptake and washout rates than fatty tissue and malignant tissue. Studies have shown that malignant tissue tends to have more rapid uptake rates and more rapid washout rates, as compared to other types of tissue, for instance. More detailed discussion of these subjects may be found in the available literature and would be familiar to those skilled in the art having the benefit of this disclosure. For the sake of brevity, such detailed discussion is omitted herein.

While cancerous tissue does exhibit distinctive image characteristics, there is a substantial amount of debate in the medical community as to certain rules or formulas that can be used to definitively make a diagnosis. The rules that may apply to one patient may not apply to another. Plus, each individual doctor may prefer to use his/her own rules or modify existing rules on a per-patient basis. As will be described later below, one embodiment of the invention provides an apparatus that can apply various (and sometimes very different) rules to process received image data and then to distribute the processed image data to appropriate remote terminals.

In FIG. 1, an object to be examined, in this case the patient's body 20, is shown. A slice 26 of the body 20 under examination is scanned and the data collected. The data are collected, organized and stored in a signal-processing module 18 under control of a computer 14. A display 15 may display the data as they are collected and stored. It may also provide an interface for the user to interact with and control the system. A power supply 16 provides power for the system.

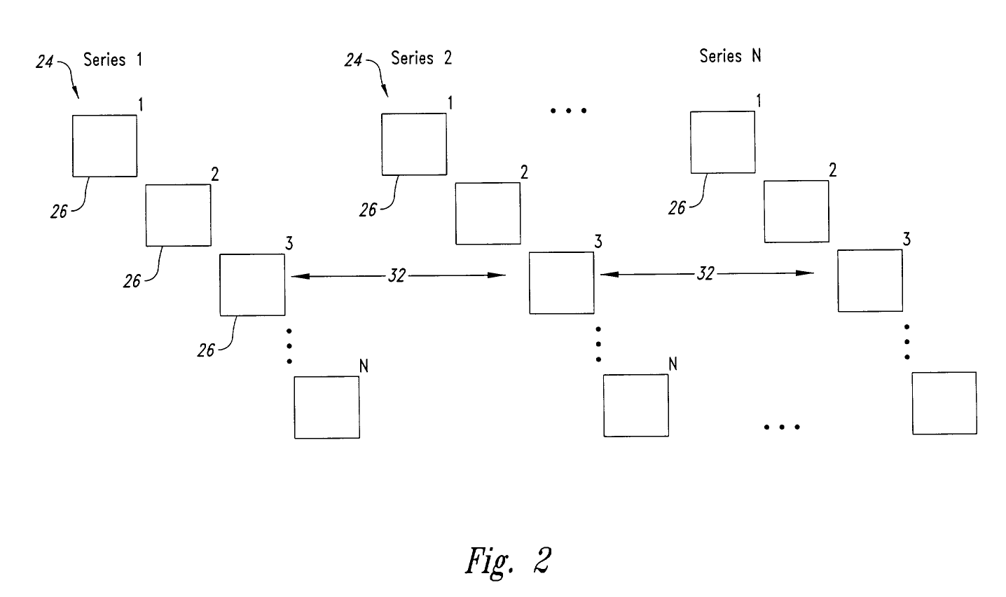

FIG. 2 illustrates the image data that may be collected by an imaging device according to one embodiment of the present invention. The medical images that are obtained can be considered as being organized in a number of different series 24. Each series 24 is comprised of data that is collected by a single technique and its corresponding imager settings. For example, one series 24 may be made up of T1-weighted images. A second series 24 may be made up of T2-weighted images. A third series 24 may be made up of a spin echo sequence (SE). Another series 24 may be made up of a STIR or inversion recovery sequence. A number of series may be obtained during the data collection process and provided to the centrally located apparatus of one embodiment of the invention. It is typical to obtain between six and eight series 24 and in some instances, ten or more different series 24 of data for a single patient during a data collection scan. In one embodiment, the different series may have a temporal relationship relative to each other.

Each series 24 is comprised of a large number of images, each image representing a slice 26 within the medical body under examination. The slice 26 is a cross-sectional view of particular tissues within a plane of the medical body under interest. A second slice 26 is taken spaced a small distance away from the first slice 26. A third slice 26 is then taken spaced from the second slice. A number of slices 26 are taken in each series 24 for the study being conducted until N slices have been collected and stored. Under a normal diagnostic study, in the range of 25-35 spatially separated slices are collected within a single series. In other situations, 80-100 spatially separated slices are collected within a single series. Of course, in a detailed study, the number of slices 26 being obtained may be much higher for each series. For example, it may number in the hundreds in some examples, such as for a brain scan, when a large amount of data is desired, or a very large portion of the medical body is being tested.

Generally, each series 24 has the same number of slices, and further, a slice in each series is taken at the same location in the body as the corresponding slice in the other series. In some situations, slices indexed with the same number in the different series 24 are from the same location in the human body in each series. In other situations, slices in the different series 24 that are taken from the same location in the human body are indexed with different numbers. A slice set 32 is made up of one slice from each of the series taken at the same location within the medical body under study, the appropriate slices may be placed in the slice set 32 by one embodiment of the invention during processing of received image data. For example, a group made of slice #3 from each of the series 24 would comprise a slice set 32 of aligned slices, assuming that all of the slices indexed as #3 are taken from the same spatial location within the body. Being able to assemble and understand the various centrally located and processed data in a slice set 32, from a remote display terminal, can be very valuable as a diagnostic tool.

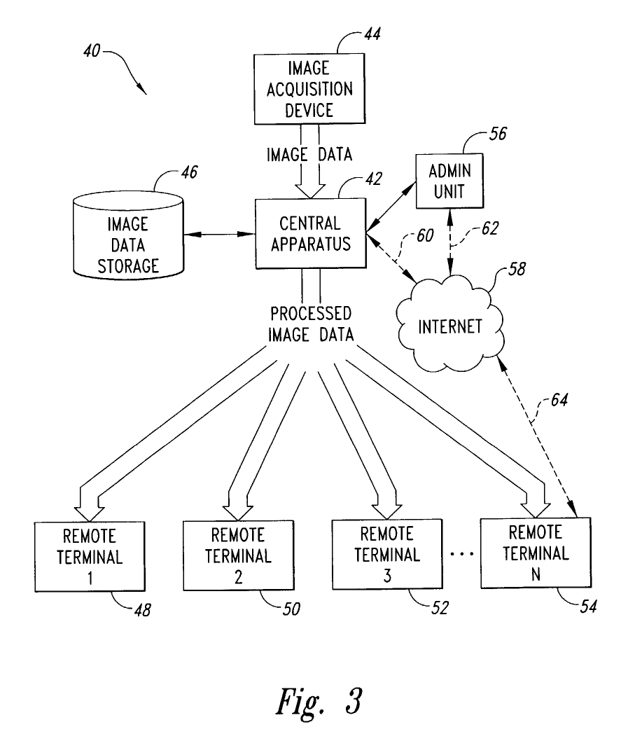

FIG. 3 is a block diagram of a network 40 having an apparatus 42 that can provide centrally located pre-processed image data to remote terminals in accordance with an embodiment of the invention. The network 40 may be located in a hospital, research institution, laboratory, or other establishment where images are acquired and analyzed, for instance. An image acquisition device 44, such as the imaging device (and related equipment) depicted in FIG. 1, acquires images using a suitable technique, including but not limited to, NMR, MRI, CT, ultrasound, x-ray, positron emission tomography (PET), or others. The image data may then be organized into series and slices, and then provided to the apparatus 42.

In one embodiment, the image data (in electronic digital or analog format) is provided from the image acquisition device 44 to the apparatus 42 via a hardwire or wireless communication links. The image data may be “pushed” to the apparatus 42 as the image data becomes available, without the apparatus 42 having to explicitly request or query the image acquisition device 44 for the image data. Alternatively or in addition, the image data may be “pulled” by the apparatus 42 from the image acquisition device 44 via a query on an as-needed basis. Still alternatively or in addition, the image data may be provided to the apparatus 42 via a portable storage medium, such as CD, diskette, magnetic tape, and the like.

The apparatus 42 is coupled to an image data storage unit 46. The storage unit 46 can comprise one or more machine-readable storage media, such as a hard disk, database, server, or other mass data storage device that can store image data. The stored image data can include the image data that is received from the image acquisition device 44 and that is waiting for processing by the apparatus 42. The stored image data can also include images that have been processed by the apparatus 42 and that are to be distributed to one or more remote terminals.

The stored image data can include multiple series of slices, such as depicted in FIG. 2 above, in digital image format or other suitable electronic format. It is understood that the apparatus 42 need not necessarily receive images that are organized in series or slices—in fact one embodiment of the apparatus 42 can perform slice arrangement in a manner that spatially related slices are aligned or otherwise linked or identified to each other. In one embodiment, the processed image data can be indexed in the storage unit 46 according to institution name, physician name, patient name, patient ID, type of study (e.g., post-contrast series, pre-contrast series, subtraction series, and the like), series and slice identification numbers, dates of acquisition, acquisition technique used, body spatial location, remote terminals that will receive the image data, and others. Moreover, the various images can be indexed so that spatially related slices from different series are linked together or otherwise grouped so that they may be viewed in relationship to one another at the remote terminal(s) 48-54. Based on this indexing system, the appropriate image data can be retrieved from the storage unit 46 by the apparatus 42, and then sent to the corresponding remote terminal(s) 48-54. At any of the remote terminals 48-54, a doctor can request images via a patient list, for instance, that correlates to the indexing criteria used.

In one embodiment, the storage unit 46 can store color overlays. The color overlays can be overlaid over black and white ones of the images by the apparatus 42, to highlight tissues of interest according to various color schemes. For example, tissue in some images that are extremely likely to be cancerous may be overlaid in red color, while less suspect tissue may be highlighted in blue color. In some embodiments, the color is integrated into black and white images, rather than or in addition to being overlays. Example techniques that may be used by one embodiment of the present invention to provide colored images for purposes of analysis and diagnosis are disclosed in U.S. patent application Ser. No. 09/990,947, entitled “USER INTERFACE HAVING ANALYSIS STATUS INDICATORS,” filed Nov. 21, 2001, assigned to the same assignee as the present application, and which is incorporated herein by reference in its entirety. An acceptable technique for selecting a region of interest, performing clustering, and then carrying out analysis on the pixels of the medical image data are described in co-pending U.S. patent application Ser. No. 09/722,063, entitled “DYNAMIC THRESHOLDING OF SEGMENTED DATA SETS AND DISPLAY OF SIMILARITY VALUES IN A SIMILARITY IMAGE,” filed on Nov. 24, 2000, assigned to the same assignee of the present application, and which is incorporated herein by reference in its entirety. Also of interest is U.S. patent application Ser. No. 09/721,931, entitled “CONVOLUTION FILTERING OF SIMILARITY DATA FOR VISUAL DISPLAY OF ENHANCED IMAGE,” filed on Nov. 24, 2000, and which is also assigned to the same assignee of the present application and incorporated herein by reference in its entirety. For the sake of brevity, the details disclosed in these co-pending applications are not repeated herein.

The remote terminals 48-54 are coupled to the apparatus 42 to receive processed image data therefrom. In one embodiment, the remote terminals 48-54 can comprise reading terminals or display terminals, such as PACS terminals. The remote terminals 48-54 may be inexpensive and simple devices with limited image processing capability, thereby relying on the apparatus 42 to perform image processing, sorting, or other advanced operation. In another example embodiment, one or more of the remote terminals 48-54 may be personal computers (PCs) or portable wireless devices with display screens.

Hardwire or wireless links may be used to communicatively couple the apparatus 42 to the remote terminals 48-54. The remote terminals 48-54 may be installed at geographically diverse locations in an institution, such as at different wards, floors, offices, or wings of a hospital. In one embodiment, each remote terminal 48-54 may be assigned with a specific address or identifier that correlates to the indexing present in the storage unit 46, which the apparatus 42 can use to determine which images to send to a particular remote terminal. For example, the remote terminal 48 may have an identifier that indicates that it is used by Doctor X and Doctor Y Therefore, the apparatus 42 sends only processed image data relevant to these two doctors to the remote terminal 48, unless instructed otherwise (e.g., Doctor Y requests patient images from Doctor W's patients).

Alternatively or in addition, the identifiers of the remote terminals 48-52 may be used to indicate the type of images that they are to receive, as opposed to the specific doctors that use the particular remote terminal(s) 48-54. For example, the remote terminal 50 may be designated to receive MR images of brains, while the remote terminal 52 may be designated to receive MR images of breasts.

In one embodiment, the apparatus 42 pushes the relevant images to the corresponding remote terminal(s) 48-54, independent of a query specifically requesting certain images. Alternatively or in addition, the apparatus 42 only sends images to the corresponding remote terminal(s) 48-54 in response to a specific query from that remote terminal (e.g., a “pull” of image data from the apparatus 42).

An administration unit 56 can be communicatively coupled to the apparatus 42, including being integrated with the apparatus 42 itself. In one embodiment, the administration unit 56 is used for configuration of the apparatus 42, including input of parameters to be used to process the image data to be received from the image acquisition device 44. For example, if a certain doctor prefers to see only MR images that depict 80% enhancement rates during contrast uptakes, then a system administrator can configure the apparatus 42 to process and sort images for that doctor using these parameters, while images having tissue that do not qualify under the requisite parameters are not provided to the doctor's remote terminal.

In one embodiment, the apparatus 42 may be configured via the administration unit 46 with a flexible rules-based system for processing image data, where any one of a plurality of different rules may be automatically used (after the rules are applied to initial baseline sample images), with the rules being based on the doctor's preferences, the type of image data received, medically validated results, or other factors. An example of a rules-based technique for processing medical images and which may be used by one embodiment of the invention is disclosed in U.S. patent application Ser. No. ______ [Attorney Docket No. 200135.412], entitled “RULES-BASED APPROACH FOR PROCESSING MEDICAL IMAGES,” filed concurrently herewith, with inventor Justin P. Smith, assigned to the same assignee as the present application, and which is incorporated herein by reference in its entirety.

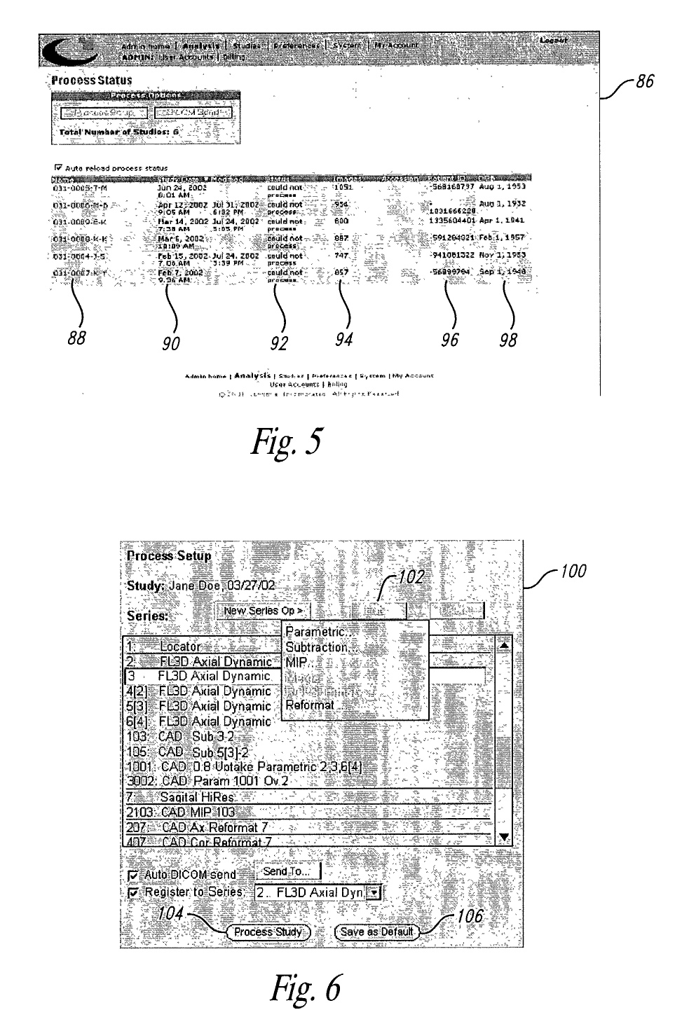

The administration unit 56 can be used for other purposes, including but not limited to monitoring the status of the image data being processed and sent to the remote terminal 48-54, troubleshooting and maintenance, organizing the image data stored in the storage unit 46, and others. FIGS. 5-9 shows example screen shots of various administrative interfaces that may be used via the administration unit 56, and which will be described later below.

In one embodiment, the administration unit 56 may communicate with the apparatus 42 via a communication network, such as an Internet 58. This allows the system administrator to access the administration unit 56 and/or the apparatus 42 from any terminal having connectivity to the Internet 58, and to perform configuration and maintenance operations using web-based (or browser-based) interfaces. Internet communication links are depicted in FIG. 3 by the broken lines 60 and 62.

Alternatively or in addition in an embodiment, one of the remote terminals, such as the remote terminal 54, may have system administration capabilities. Thus, the system administrator or a user can configure the apparatus 42 (including configuration changes) via their remote terminal. The remote terminal 54 may perform configuration of the apparatus 42 via the Internet 58 by way of a communication link 64, or via a direct connection (not shown) to the apparatus 42.

In one embodiment, the apparatus 42 may be coupled to a workstation (not shown), similar to conventional workstations that are used for image processing. Such a workstation may be used for additional image processing to supplement the image processing performed by the apparatus 42, or as a “back-up.” Alternatively or in addition, the workstation and apparatus 42 may complement each other with regards to certain types of image processing tasks.

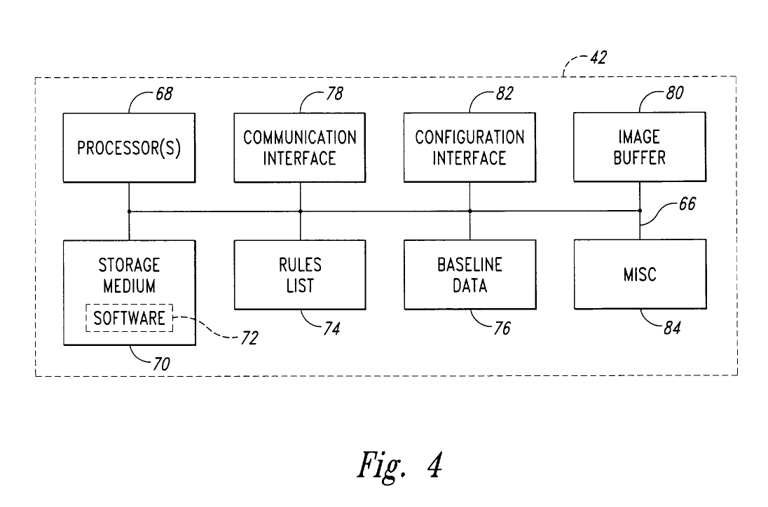

FIG. 4 is a block diagram showing one embodiment of the apparatus 42 of FIG. 3 in more detail. For simplicity of explanation, not all of the possible components of the apparatus 42 are shown—only components relevant to understanding operation of the embodiment are depicted. Moreover, the various components and their associated operations may be integrated or otherwise combined, without necessarily having to be separate components. A line 66 represents communication between the various components of the system 66. The line 66 can be an actual bus or other connection, whether hardware or software.

The apparatus 42 includes one or more processors 68. The processor 68 can comprise a digital signal processor (DSP) chip, an image processor, a microprocessor or microcontroller, or other type of processor capable to process image data. In one embodiment, processors similar to those used by current workstations may be implemented as the processor(s) 68.

The processor 68 is coupled to a machine-readable storage medium 70 to cooperate with software (or other machine-readable instruction) 72 stored thereon. The software 72 can include an operating system to manage and control operation of the various components of the apparatus 42. The software 72 can also include image-processing software that can apply parameters (including rules) to the received image data, calculate pixel intensities, compare calculated pixel intensities to known quantities, add color overlays to highlight tissue of interest, generate graphs and charts from the image data, store to and retrieve image data from the storage unit 46, and other operations associated with processing image data.

One embodiment of the apparatus 42 includes a rules list 74. The rules list 74 contains rules or other parameters by which received image data is to be sorted or otherwise processed. The rules list 74 may be stored in the storage medium 70 or in some other location in the apparatus 42, and programmed into the apparatus 42 by way of the administration unit 56. Via use of the rules, images processed under different conditions and/or meeting different criteria can be provided to doctors on case-specific basis at their remote terminal(s) 48-54.

The rules list 74 can include several of many rules that are available from existing literature or that are developed as medical research continues to validate new findings. An example of a “rule” is to provide contrast images to certain doctors, where the images show an enhancement rate of at least 80%. As a person skilled in the art would appreciate, this enhancement rate may be varied in the apparatus 42 according to doctor preferences or based on the particular patient or tissue being examined. As a person skilled in the art would also appreciate, other rules can be programmed for washout rates, time interval durations, types of images acquired, number of series and images involved, and other factors too numerous to detail herein, plus combinations thereof.

The rules-based techniques disclosed in the co-pending application identified above may be used by the apparatus 42. Additional example rules may be found in Christiane K. Kuhl et al., “DYNAMIC BREAST MR IMAGING: ARE SIGNAL INTENSITY TIME COURSE DATA USEFUL FOR DIFFERENTIAL DIAGNOSIS OF ENHANCING LESIONS?,” Radiology, vol. 211, no. 1, April 1999, pp. 101-110; and in Nola M. Hylton, “VASCULARITY ASSESSMENT OF BREAST LESIONS WITH GADOLINIUM-ENHANCED MR IMAGING,” MRI Clinics of North America, vol. 9, no. 2, May 2002, pp. 321-331, with both of these articles being incorporated herein by reference in their entirety.

One embodiment of the apparatus 42 may include baseline data 76 stored in the storage medium 72 or elsewhere. The baseline data 76 can include sample image data sets to which the specific rules are applied. For example, if a certain doctor prefers to use 3 post-contrast series for his analysis with an enhancement rate threshold of 80%, then the 80%-rule is applied to an initial data set comprising 3 post-contrast series to “teach” the apparatus 42 how to classify similar data sets in the future. Then, whenever any 3 post-contrast series for that doctor are subsequently provided from the image acquisition device 44, the apparatus 42 knows that the 80%-rule is to be applied to the new series. Other types of baseline data 76 may be used in conjunction with or combined with the rules list 74.

In one embodiment, the image data processing performed by the processor 68, in cooperation with the software 72 and the applicable rule(s) from the rules list 74, includes processing the images to identify and group spatially related images. For example, a set of slices taken from a particular spatial location of a patient's body may include several pre-contrast images and several post-contrast images (e.g., “aligned images”). One embodiment of the apparatus 42 groups these images together so that they may be intelligently compared by a doctor at one of the remote terminals 48-54, including registration if appropriate. Additionally, the apparatus 42 may calculate (or otherwise generate from the received image data) a subtraction series, parametric series (where color may be added to highlight tissues of interest), maximum intensity projection (MIP) series, reformatted series, or other series and combinations thereof, and send them to the appropriate remote terminal(s) 48-54. For example, a subtraction series provides images having a difference in contrast between images from two other series.

The apparatus 42 includes a communication interface 78, such as a network card. The communication interface 78 allows the apparatus 42 to receive image data from the image acquisition device 44, and allows the apparatus to transmit processed image data to appropriate ones of the remote terminals 48-54. The communication interface 78 also allows the apparatus 42 to read from and write to the storage unit 46. In one embodiment, the images sent to and from the communication interface 78 are in Digital Imaging and Communications in Medicine (DICOM) format.

The apparatus 42 may include one or more image buffers 80. The image buffer 80 can store image data that is received from the image acquisition device 44 prior to storage of the data (if applicable) in the storage unit 46. The image buffer 80 can also operate as a container to hold image data while it is being processed by the processor 68 and software 72. Still further, the image buffer 80 can operate as an intermediate location to hold processed image data retrieved from the storage unit 46, before such processed image data is sent to appropriate ones of the remote terminals 48-54.

A configuration interface 82, such as an input/output mechanism, can interface with the configuration unit 80 to provide configuration information (such as new or revised rules) to the apparatus 42. The apparatus 42 includes miscellaneous other components 84, which for the sake of simplicity are not detailed herein because they would be familiar to those skilled in the art having the benefit of this disclosure.

FIGS. 5-9 show different example screen shots of administrative interfaces that may be used to configure the apparatus 42 of FIGS. 3-4 according to various embodiments of the present invention. Such administrative interfaces may be provided at the administration unit 56, for instance. It is appreciated that the administrative interface(s) depicted therein are merely illustrative. Other embodiments can provide administrative interfaces with different layouts, informational displays, controls, subject matter, and the like. Moreover, administrative interfaces depicted in FIGS. 5-9 are not intended to be exhaustive of all interfaces that can be used.

FIG. 5 shows an example of an administrative interface 86 to view and edit image-processing studies. The listed study information can include patient names 88, study dates 90 (e.g., the dates when the images were acquired), study processing status 92, number of images in a study 94, patient identifier 96, and patient date of birth 98. For the study processing status 92, possible message indicators can include “receiving” (from the image acquisition device 44), “sending” (to one or more of the remote terminals 48-54), “done” (processing finished), and “error” (cannot match the received data with known parameters).

FIG. 6 shows an example of an administrative interface 100 to display and edit image-processing settings. These include controls to change default settings for processing subsequent studies or to modify existing settings. An edit button 102 allows the system administrator to change settings for a selected series. A process study button 104 is used to process the current study with the current configuration settings. A save as default button 106 allows the system administrator to save the current configuration settings as default.

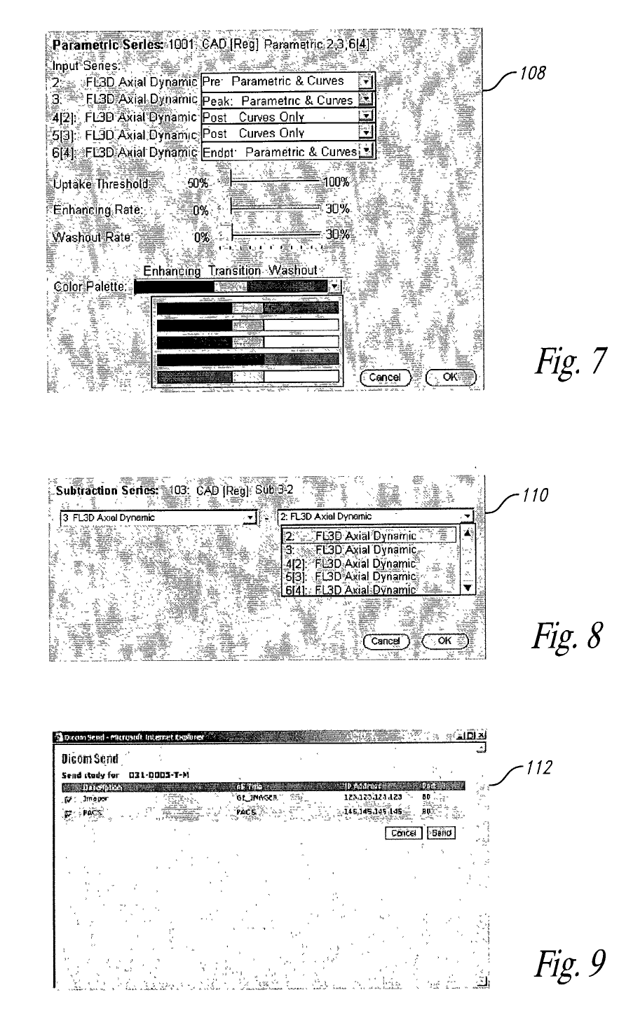

FIG. 7 shows an example of an administrative interface 108 to allow the system administrator to edit or create a new parametric series. FIG. 8 an example of an administrative interface 110 to allow a user to edit or create a subtraction series, where a “subtraction” series provides images having a difference in contrast between images from two other series. Other administrative interfaces may be provided to edit or create other types of series.

FIG. 9 shows an example of an administrative interface 112 to allow the system administrator to select which receiving device to send the processed image data. For example, the processed image data may be selectively sent to PACS devices (e.g., the remote terminals 48-54) or to a workstation.

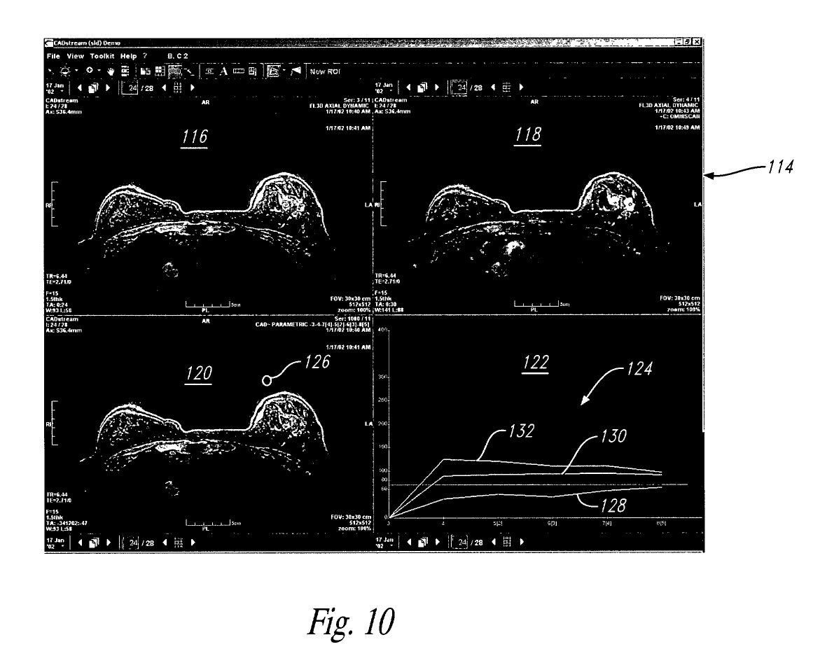

FIG. 10 shows a screen shot of a user interface that can be used by a remote terminal to present image data that has been pre-processed by the apparatus 42 of FIGS. 3-4 in accordance with an embodiment of the invention. It is appreciated that the depicted user interface is merely illustrative. Other embodiments can provide user interfaces with different layouts, informational displays, controls, displayed images, and the like.

FIG. 10 illustrates a user interface for use by medical personnel for examining medical images according one embodiment of the present invention. The user interface includes a display area 114 having one or more medical images 116, 118, and 120 shown thereon. The medical images 116-120 can be pre-processed images stored in the storage unit 46, which were processed and sorted by the apparatus 42 according to programmed parameters. The medical images 116-120 are shown as examples for illustrating examination for breast cancer and a study of whether or not the cancer has metastasized and spread to other tissues within the patient. Of course, other embodiments of the invention are applicable to all sorts of medical images of different parts of the body or to images that are not necessarily medical in nature. One embodiment of the invention may be particularly beneficial for brain image data, lymph node image data, or many other types of tissue that are susceptible to cancers or other diseases that spread to different locations within the body, including studies where contrast agents are applied.

The medical images 116-120 may be organized according to the series and slice scheme depicted in FIG. 2, if appropriate. Color may be present in one or more of the medical images 116-120 to highlight potential tissues of interest. The medical image 116 may be considered as a pre-contrast image, while the medical images 118 and 120 may be post-contrast images.

In one embodiment, one or more of the images 116-120 can comprise images generated by the apparatus 42, plus data of potential interest to the doctor. For instance, one of the images 116-120 may have a region of interest highlighted in color. The other images 118-120 may then show that colored region of interest in isolation and magnified, along with accompanying data such as size, location, or other information that is potentially useful to the reviewing individual. Alternatively or in addition, this new image data may be displayed as their own series. This newly generated data may be displayed in separate windows, series of windows, overlays, or other presentation interface. The embodiment of the apparatus 42 can automatically perform the operations to create this new image data, and then present it to the appropriate remote terminal(s) 48-54.

In one embodiment, the display area 114 can present a window 122 having a chart 124 (or other graphical data) shown therein. In this example, the chart 124 shows % change in pixel intensity (vertical axis) versus time (horizontal axis). The % percent change is compared using the pre-contrast image 116 as the baseline.

In operation, a cursor 126 or other navigation element may be positioned over any of the pixels of the medical images 118 or 120, and a corresponding curve is generated in the window 122 that tracks the % percent change in intensity over a period of time for the selected pixels. In one embodiment, the generated curves dynamically change in real-time as the user moves the cursor 126 from one image position to another.

In the chart 124, a curve 128 can represent non-cancerous tissues, which are the non-colored areas in the medical images 118 or 120 (or areas that are colored but do not represent suspect tissue). As illustrated, the curve 128 is characterized by a gradual uptake rate and gradual washout rate of the contrast agent.

A curve 132 is generated when the cursor 126 is positioned over colored areas of the medical images 118 or 120, which may represent cancerous tissue. As illustrated, the curve 132 is characterized by a steep uptake rate and faster washout rate, as compared to the curve 128, and is thus strongly suggestive of cancerous tissue.

A curve 130 is a curve corresponding to any of the regions that the user has chosen to save or “mark” for comparison purposes, as one or more other curves are dynamically generated. In one embodiment, the color of the curves 128-132 can match the color of the regions in the images 118-120 that have been selected by the cursor 126. Moreover, the curves 128-132 may be shown concurrently as depicted in FIG. 10, or shown individually or in selected groups.

The various medical images 116-120 are processed by the apparatus 42, including sorting and color overlaying, and then provided to one or more of the remote terminals 48-54 so that they may be displayed as shown in FIG. 10. In one embodiment, the calculation and other processing used to generate the curves 128-132 of the chart 124 may also be performed by the apparatus 42, and then the remote terminals 48-54 receive the processed data to render the curves 128-132, in response to user selection of regions of interest, for instance.

In conclusion and as evident from the embodiments described above, every patient can receive a certain standard of care with the apparatus 42, which might not be happening now with current systems. Time is critical in terms of scheduling MR scans and any post image processing. If the MR technician runs out of time with current systems, MIPs might not get created or curves might not get created for every region of interest. With an embodiment of the apparatus 42, the MR technician need not attend to any image processing—the apparatus 42 performs such processing, and every patient gets the same set of processed images that were created (according to exactly the parameters desired by their radiologist).

Using an embodiment of the apparatus 42 to create enhanced parametric images (customized to whatever parameters the radiologist is interested in) eliminates the need for the radiologist to create single curves for each suspicious area on his terminal. The radiologist does not have to identify suspicious areas and then create the contrast curves. The apparatus 42 provides the information that the radiologist wishes to look for (e.g., 80% enhancement in the first minute, followed by a 10% washout) and highlights exactly those pixels that follow the specified rules. The apparatus 42 then applies those rules the same way for every appropriate patient.

In terms of breast MRI, the number of images that the radiologist has to review is huge—studies can easily reach 1000 images/patient. An embodiment of the apparatus 42 creates additional images, but due to the image processing, these new series condense the amount of data into images that are much easier to read. For example, with parametric series, 3 series are condensed into 1 with areas highlighted according to rules specified by the radiologist, such as depicted in FIG. 10. So instead of looking at 3 series with no easily detected suspicious areas, the radiologist can look at a single series with all suspicious areas highlighted.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

For instance, the image under study can be any acceptable image for which a detailed investigation is to be performed by comparing images of the same object to each other or images of one object to images of another object. In one embodiment, the object under study is human tissue and the region of interest corresponds to cells within the human body having a disease or particular impairment, such as cancer, Alzheimer's, epilepsy, or some other tissue that has been infected with a disease. Alternatively or in addition, the region of interest may be certain types of tissue that correspond to body organs, muscle types or certain types of cells for which an analysis or investigation is desired. As a further alternative or addition, the object under investigation may be any physical object, such as an apple, bottles of wine, timber to be studied, or other detailed object for which an analysis is to be performed and a search made for similar regions of interest within the object itself, or for one object to another.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
configuring a central location to centrally process image data and to distribute the processed image data to at least some remote recipients having minimal image data processing capabilities;
receiving the image data at the central location;
centrally processing the received image data at the central location according to at least one image processing parameter, from among a plurality of available image processing parameters, associated with at least one of the remote recipients; and
sending the processed image data to the remote recipient associated with the image processing parameter used during the central processing.

2. The method of claim 1 wherein the image data include medical images, and wherein centrally processing the received image data includes processing the medical images to highlight tissues of interest.

3. The method of claim 2 wherein the medical images include magnetic resonance images of tissue enhanced by contrast agents.

4. The method of claim 1 wherein the at least one image processing parameter associated with the remote recipient includes doctor preferences.

5. The method of claim 1 wherein the at least one image processing parameter associated with the remote recipient includes a type of image designated for display by the remote recipient.

6. The method of claim 1 wherein the remote recipients comprise picture archive and communication system (PACS) terminals.

7. The method of claim 1 wherein configuring the central location to centrally process the image data includes programming the central location with the parameters from at least one administrative interface.

8. The method of claim 7 wherein programming the central location with the parameters from at least one administrative interface includes providing access to the administrative interface via an Internet.

9. The method of claim 7 wherein programming the central location with the parameters from at least one administrative interface includes providing access to the administrative interface via one of the remote recipients.

10. The method of claim 7 wherein the received image data include medical images organized into series, and wherein programming the central location with the parameters from at least one administrative interface includes programming the central location to process the medical images differently based on a type of series.

11. The method of claim 1 wherein the image data include medical images, and wherein centrally processing the received image data includes processing the medical images to highlight tissues of interest in color, the method further comprising:
at the central location, calculating a change in intensity of pixels in at least one of the images;
in response to user selection of the pixels, sending graphical data representative of the change in pixel intensity to a remote recipient from where the pixels were selected to allow that remote recipient to display the graphical data; and
if there is user selection of other pixels, calculating a corresponding change in pixel intensity at the central location and sending new graphical data representative of this pixel intensity to that remote recipient, in a manner that the remote recipient can dynamically display the graphical data as user selection of pixels changes.

12. The method of claim 11 wherein the displayed graphical data have a color that dynamically match the color of tissues of interest that are subject to user selection.

13. The method of claim 1 wherein centrally processing the received image data includes generating new image data from the received image data.

14. The method of claim 1 wherein centrally processing the received image data includes identifying and linking spatially related images.

15. An article of manufacture, comprising:
a machine-readable medium for a central location coupled to receive medical image data and to distribute the medical image data to at least some remote terminals having minimal image data processing capabilities, the machine-readable medium having instructions stored thereon to:
centrally process the received medical image data according to at least one image processing parameter, from among a plurality of available image processing parameters, associated with at least one of the remote terminals; and
send the processed medical image data to the remote terminal associated with the image processing parameter used during the central processing.

16. The article of manufacture of claim 15wherein the instructions to centrally process the received medical image data includes instructions to process the medical image data to highlight tissues of interest in color, as enhanced by contrast agents.

17. The article of manufacture of claim 15 wherein the machine-readable medium further includes instructions stored thereon to provide at least one administrative interface to the central location and through which the parameters may be entered.

18. The article of manufacture of claim 13 wherein the administrative interface comprises a web-based interface.

19. The article of manufacture of claim 15 wherein the machine-readable medium further includes instructions stored thereon to:
calculate a change in intensity of pixels in a medical image having the medical image data;
in response to user selection of the pixels, send graphical data representative of the change in pixel intensity to a remote terminal from where the pixels were selected to allow that remote terminal to display the graphical data; and
if there is user selection of other pixels, calculate a corresponding change in pixel intensity and send new graphical data representative of this pixel intensity to that remote terminal, in a manner that the remote terminal can dynamically display the graphical data as user selection of pixels changes.

20. The article of manufacture of claim 19 wherein the instructions to centrally process the received medical image data include instructions to add color to highlight tissues of interest on the medical image, the machine-readable medium further including instructions stored thereon to display the graphical data with a color that dynamically matches the color of tissues of interest that are subject to user selection.

21. A system, comprising:
a means for configuring a central location to centrally process image data and to distribute the processed image data to at least some remote recipients having minimal image data processing capabilities;
a means for receiving the image data at the central location;
a means for centrally processing the received image data at the central location according to at least one image processing parameter, from among a plurality of available image processing parameters, associated with at least one of the remote recipients; and
a means for sending the processed image data to the remote recipient associated with the image processing parameter used during the central processing.

22. The system of claim 21 wherein the means for configuring the central location to centrally process the image data include at least one Internet-based administrative interface.

23. The system of claim 21 wherein the means for centrally processing the received image data include a means for calculating graphical data from baseline data and for dynamically calculating new graphical data for display at one of the remote locations in response to user selection of different portions of image data sent to that remote location.

24. An apparatus, comprising:
a plurality of rules to specify how received medical images are to be processed;
a storage medium to store a software program;
a processor coupled to the storage medium to cooperate with the software program to select at least one of the rules and to process the received medical images based on the selected rule; and
a communication interface coupled to the processor to send the processed medical images to at least one remote terminal associated with the selected rule, wherein the processor is adapted to perform processing of the medical images alternatively to having the medical images processed at remote terminals.

25. The apparatus of claim 24, further comprising a configuration interface coupled to the storage medium to receive at least one of changes to existing rules and new rules.

26. The apparatus of claim 25 wherein the configuration interface is coupled to provide an administrative interface via an Internet.

27. The apparatus of claim 24, further comprising an image buffer coupled to the processor to store medical images that are being processed.

28. The apparatus of claim 24 wherein the software program includes code to dynamically calculate graphical data from the medical images in response to selection of portions of a displayed medical image at the remote terminal, wherein the processor is adapted to send the calculated graphical data to the that remote terminal via the communication interface to allow that remote terminal to dynamically display different graphical data as different portions of the displayed medical image are selected.

29. The apparatus of claim 24 wherein the software program includes code to generate new medical images from the received medical images in accordance with the selected rule.

30. A system, comprising:
an image acquisition device to acquire medical images;
a plurality of rules to specify how acquired medical images are to be processed;
a storage medium to store a software program;
a processor coupled to the storage medium to cooperate with the software program to select at least one of the rules and to process the acquired medical images based on the selected rule; and
a communication interface coupled to the processor to send the processed medical images to at least one remote terminal associated with the selected rule, wherein the processor is adapted to perform processing of the medical images alternatively to having the medical images processed at remote terminals.

31. The system of claim 30, further comprising a storage unit coupled to the communication interface to store at least one of the acquired medical images and processed medical images to be sent to the remote terminal.

32. The system of claim 30 wherein the image acquisition device comprises a magnetic resonance imaging (MRI) device.

33. The system of claim 30, further comprising an administration unit to provide the rules for the software and to modify the rules.

34. The system of claim 33 wherein the administration unit includes a web-based administration interface through which to provide the rules and modifications thereof.

35. The system of claim 30 wherein the remote terminals comprise picture archive and communication system (PACS) terminals to display medical images having contrast data enhanced by the processor and software.

36. The system of claim 31 wherein the software program includes code to identify and link spatially related medical images from different series of medical images, and to index the identified and linked medical images in the storage unit.

37. The system of claim 36 wherein medical images in the storage unit are indexed according to at least one of a patient identifier and doctor identifier.
